(19) United States
(12) Patent Application Publication
(10) Pub. No.: US 2021/0332613 A1
(43) Pub. Date: Oct. 28, 2021

(54) Novel Door Latching System Configured For Foot Use

(71) Applicants: Shari Glixman, HOLLYWOOD, FL (US); Moshe Simcha Glixman, Brooklyn, NY (US)

(72) Inventors: Shari Glixman, HOLLYWOOD, FL (US); Moshe Simcha Glixman, Brooklyn, NY (US)

(21) Appl. No.: 16/860,861

(22) Filed: Apr. 28, 2020

(51) Int. Cl. E05B 53/00; E05C 3/04; E05B 1/00

(52) U.S. Cl. CPC E05B 53/001; E05C 3/041; E05Y 2900/112; E05B 1/003; E05Y 2900/132; E05B 1/0084

(57) ABSTRACT

A door latching or locking system is provided whereby the user locks and unlocks the system using their feet.

### BACKGROUND OF THE INVENTION

A significant difficulty is present when latching and or locking doors in various settings. This difficulty is even more apparent in an environment where there is easily found the spread of germs, disease and bacteria.

One such environment is present when locking and unlocking doors in a public restroom. A user will finish using the toilet facilities and unlock the door before having opportunity to wash their hands.

It is a problem that needs a simple yet effective solution.

The present invention provides a solution.

### SUMMARY OF THE INVENTION

The present invention is foot-controlled latch or lock system,

In one embodiment the system is a foot stall latch configured for use in bathroom stalls and public restrooms.

Although a primary intent is public restrooms, the system is contemplated as being used in homes, offices and other commercial and non-commercial venues including but not limited to pet gates, gates and interior doors.

The invention is configured to remove the necessity of touching the doorknob, latch or lever when entering or exiting a bathroom stall by relying solely on one's foot.

Entry/Exit/Locking/Latching hardware built solely for the intent of use with one's foot.

Entry and exit will be accessible with one's foot. Additionally, the invention is operable using any one or combination of a cane, walking stick, or additional elbow connection for handicapped bathrooms.

The invention is a mechanical locking system having protrusions, or foot treads; a foot swivel access point; at toe grab for hard to reach spots; and will be constructed specifically for foot use.

### BRIEF DESCRIPTION OF THE SEVERAL VIEWS OF THE DRAWINGS

FIG. 1 is a perspective view according to one embodiment of the present invention.

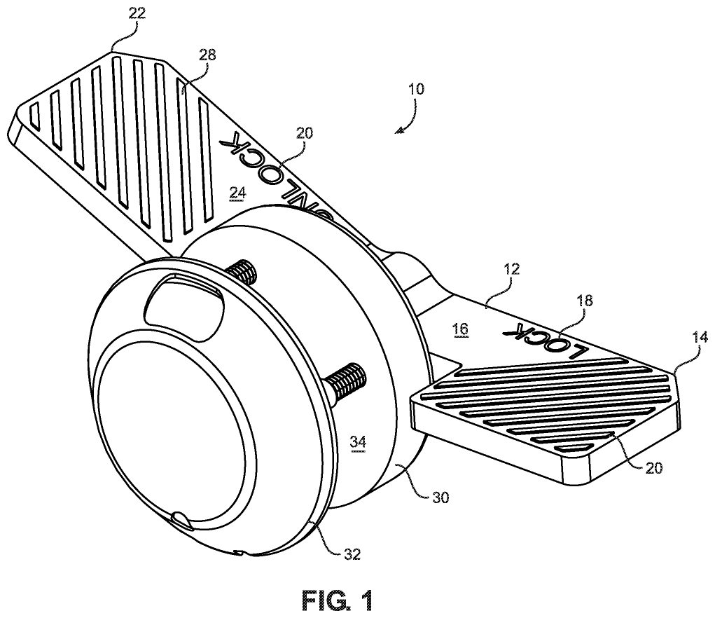

FIG. 2 is a perspective view according to one embodiment of the present invention.

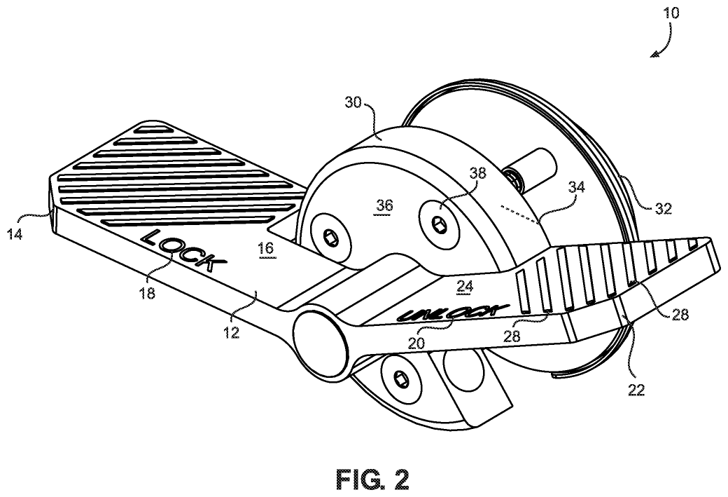

FIG. 3 is an exploded component view according to one embodiment of the present invention.

FIG. 4 is a side partial cross-section view demonstrating internal components according to one embodiment of the present invention.

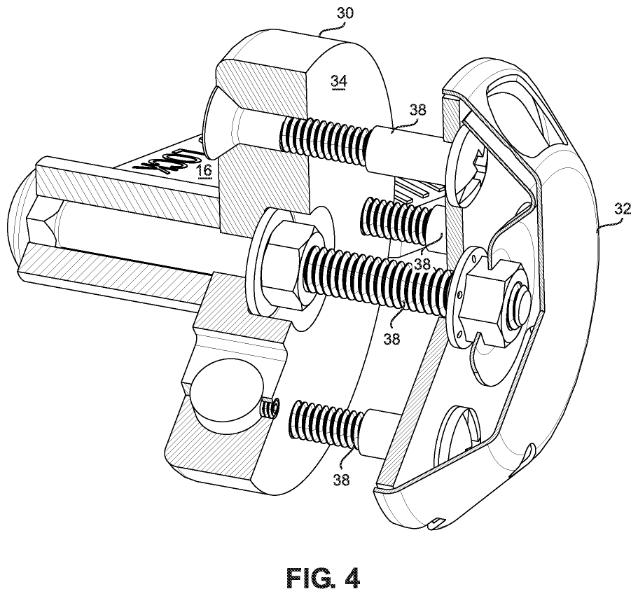

FIG. 5 is a side partial cross-section view demonstrating internal components according to one embodiment of the present invention.

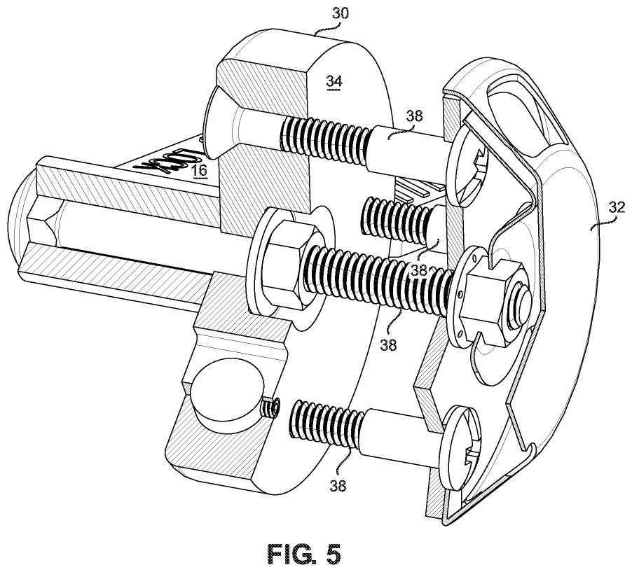

FIG. 6 is a few demonstrating the present invention in one environment of use.

FIG. 7 is a sequential view from FIG. 6 demonstrating an unlocked or open position.

FIG. 8 is a partial view of the invention demonstrating the control bar.

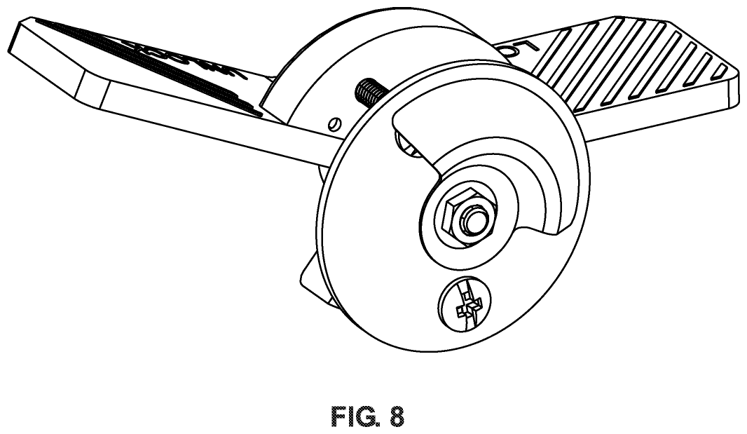

FIG. 9 is a partial view of the invention demonstrating the control bar.

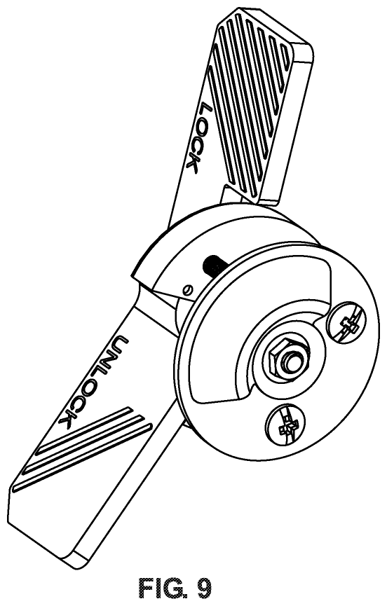

FIG. 10 is a partial view of the invention demonstrating the control bar and separated components.

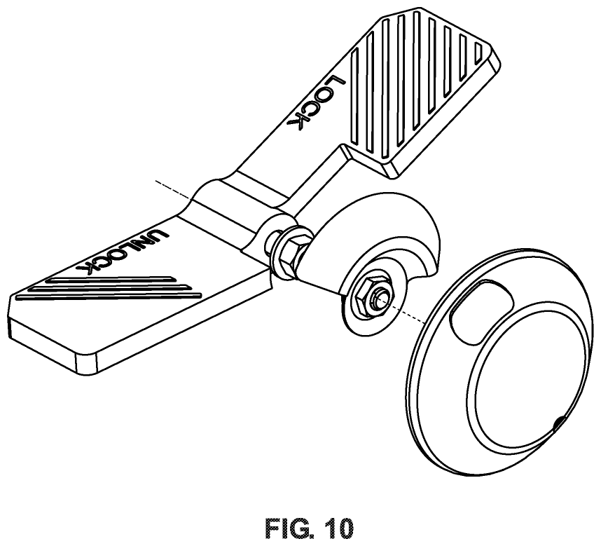

FIG. 11 is top view of the control bar demonstrating various dimensions and ratios.

FIG. 12 is a front view of the control bar.

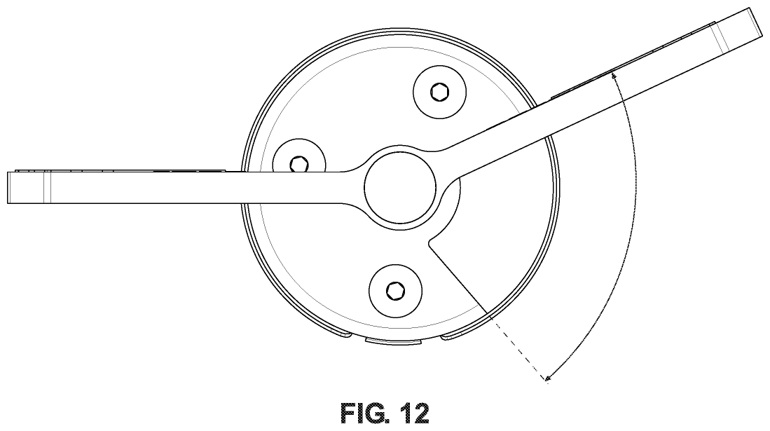

FIG. 13 is a partial top view of the control bar.

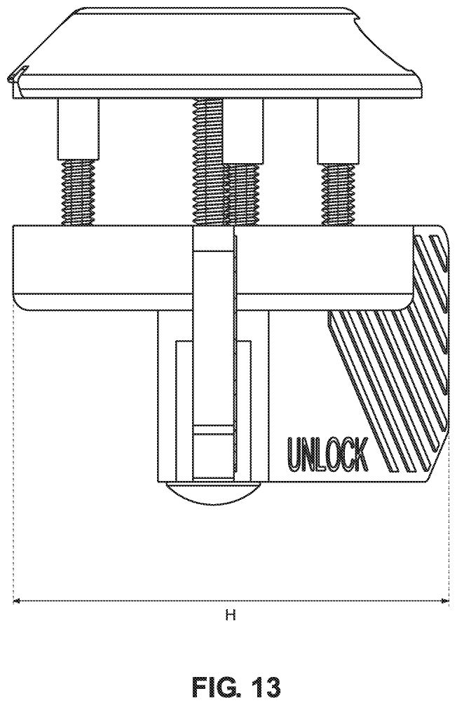

FIG. 14 is an exploded component view according to one embodiment of the present invention.

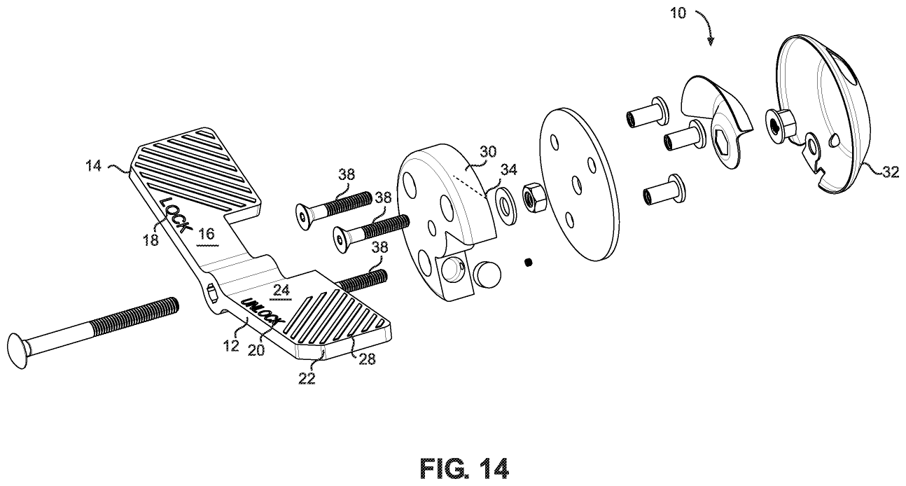

FIG. 15 demonstrates the present invention in a configuration with outswing door where the door closes on the left.

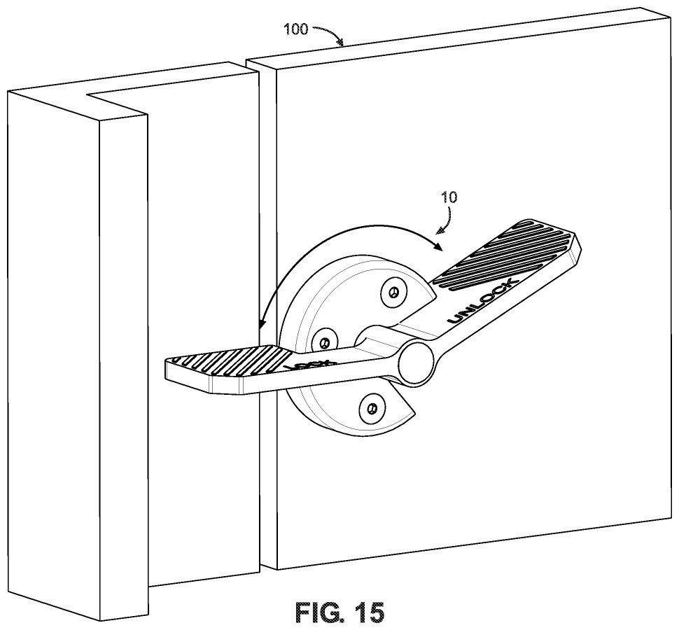

FIG. 16 demonstrates the present invention in a configuration with outswing door where the door closes on the right.

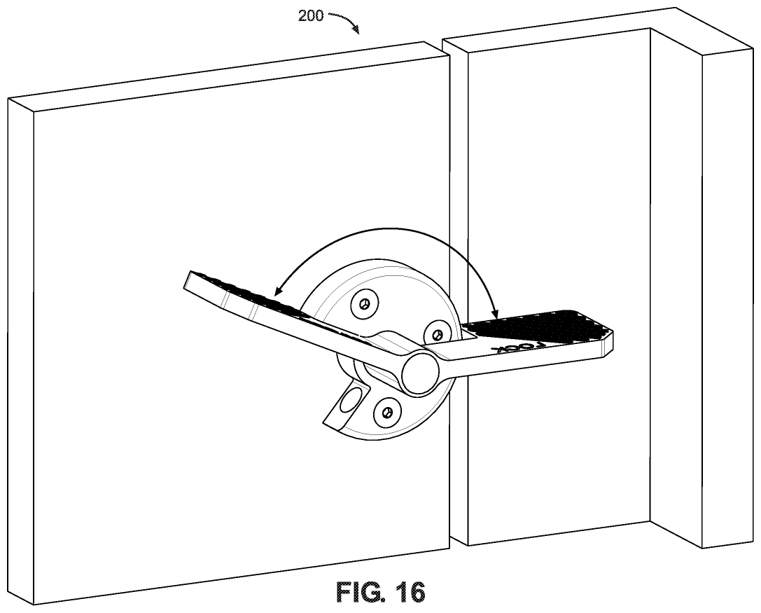

FIG. 17 demonstrates the present invention in a configuration with inswing door where the door closes on the right.

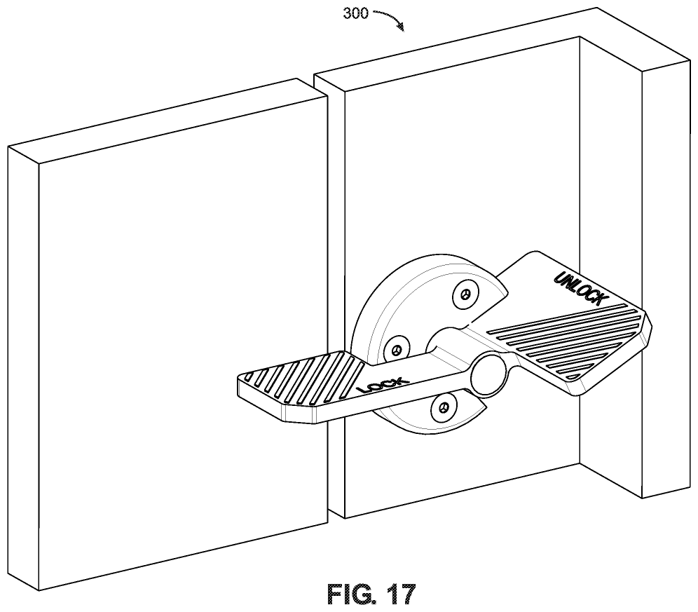

FIG. 18 demonstrates the present invention in a configuration with inswing door where the door closes on the left.

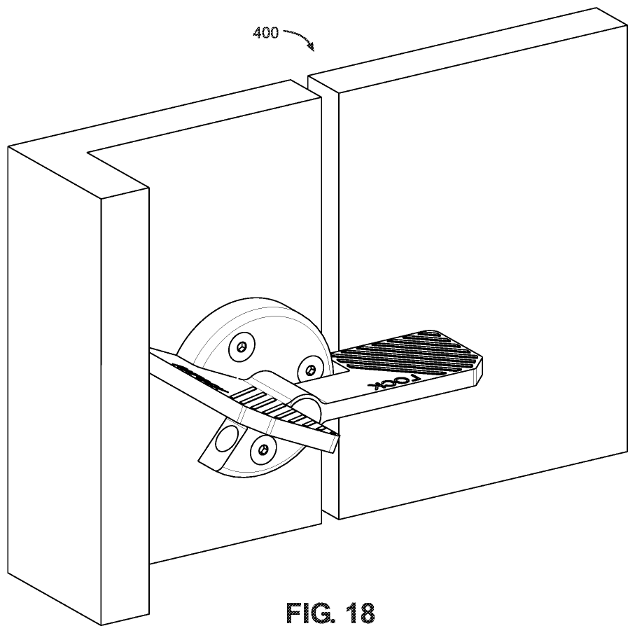

FIG. 19 demonstrates one embodiment of the invention whereby the control plate is formed of different size configurations.

FIG. 20 is an additional embodiment demonstrating and in swing configuration.

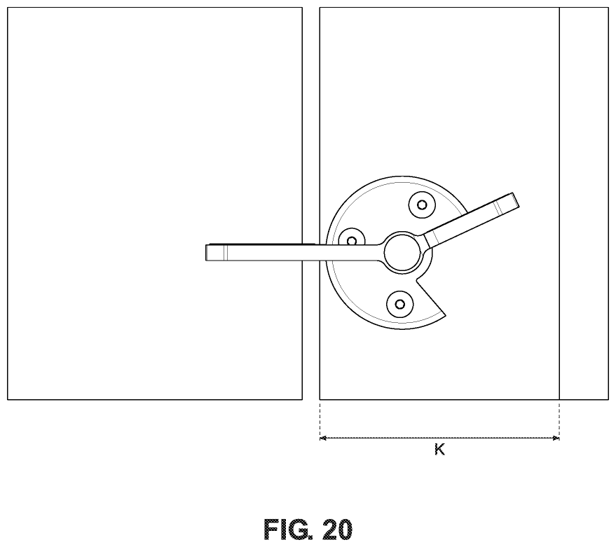

FIG. 21 is a top view from FIG. 19.

FIG. 22 is a top view from FIG. 19.

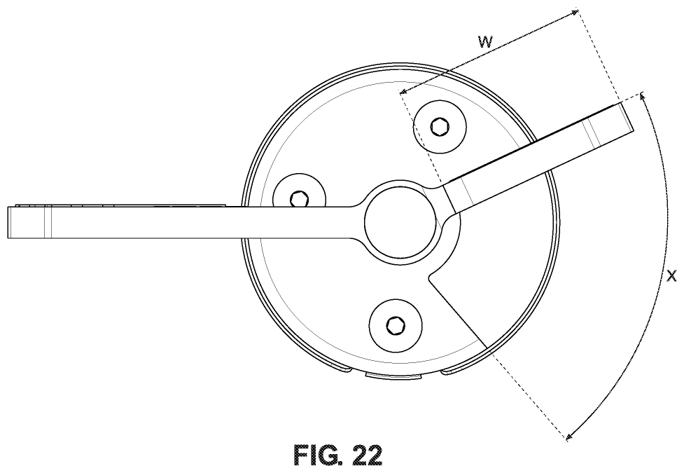

FIG. 23 is a side view from FIG. 19.

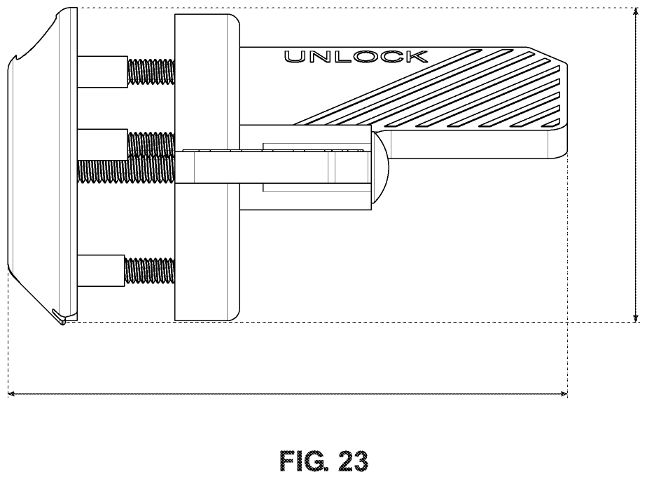

FIG. 24 is an exploded component view according to one embodiment of the present invention.

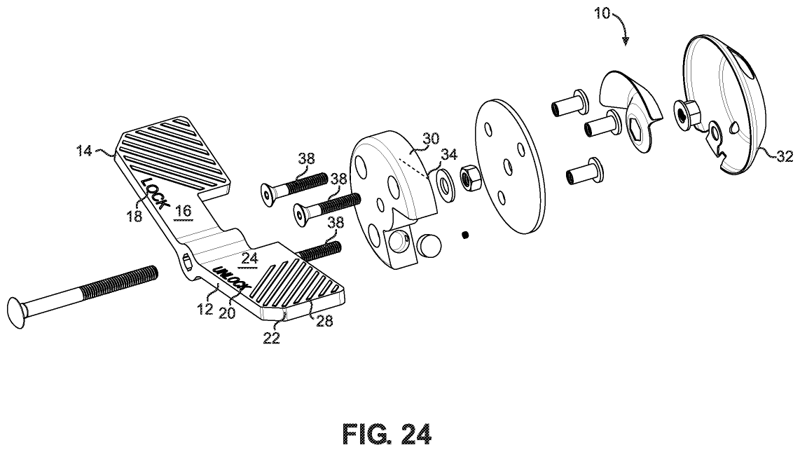

### DETAILED DESCRIPTION OF THE PREFERRED EMBODIMENT

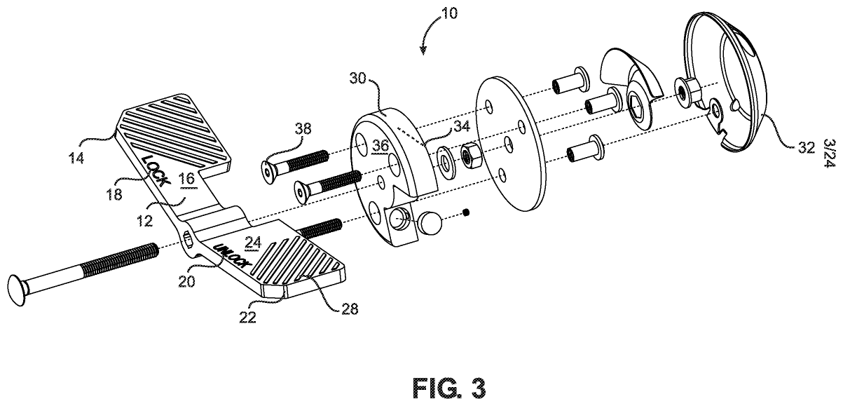

As generally understood, the system of the present invention a system 10 formed with the control bar 12. Control bar 12 is preferably a single formed piece. Control bar 12 has a first end 14 having an upper planer surface 16, indicia 18 and a plurality of protrusions 20. Control bar 12 has a second end 22 with second end upper planer surface 24 second end indicia 20 and a plurality of Second and protrusions 28. Control bar 12 interacts with proximal cap 30 in order to provide desired movement about a central axis to lock and unlock a door where system 10 is installed. Distal cap 32 encloses the components of the system as demonstrated in FIG. 3. Connecting bolts 38 ultimately attach through proximal cap 30 securing distal cap 32 into position.

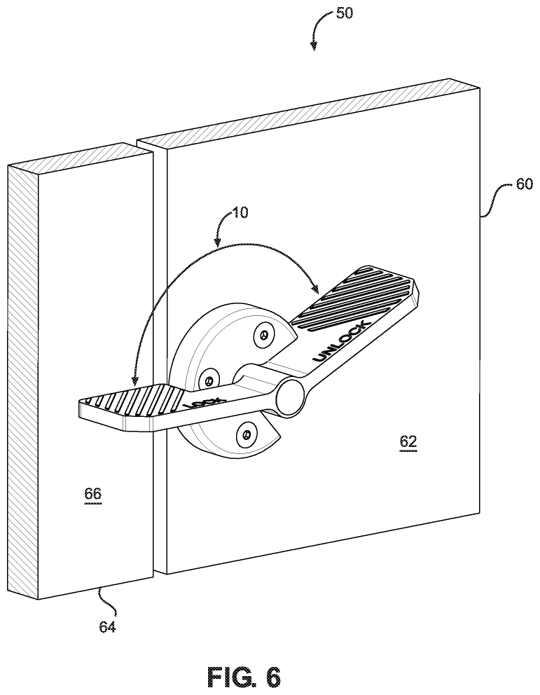

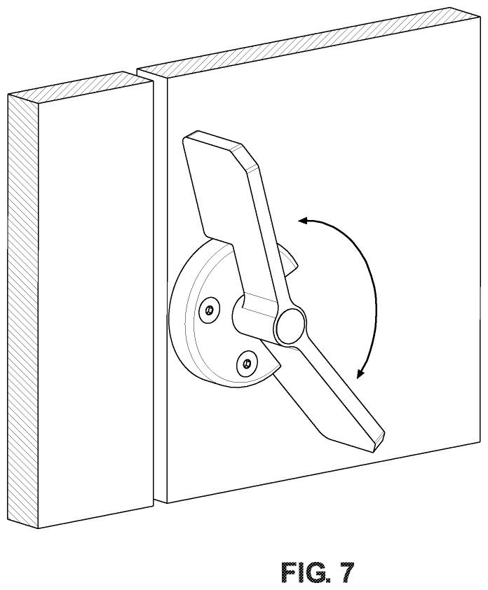

As demonstrated in FIGS. 6 and 7, is attached to door 60 on anterior surface 62, first end 14 of plate 12 serves as a lock or latch by contacting inner surface 66 of wall 64. Directional arrows demonstrates a central axis formed by one particular in the center of the circle of proximal cap 30 and secured onto plate 12.

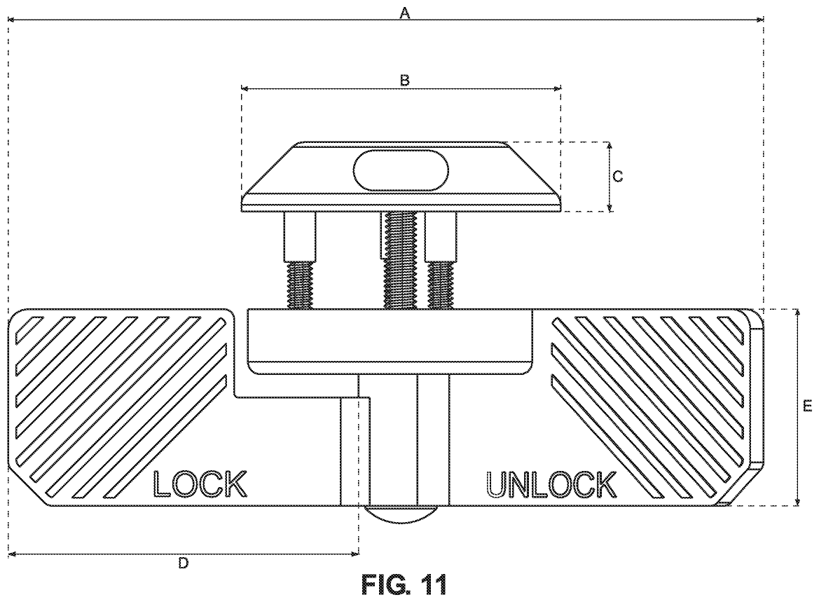

As shown in FIG. 11, there are particular dimensions that are not merely design preferences but that have been utilized based on ratios of their measurements.

Dimension A is the overall length of plate 12. Although plate 12 may not be planer, and has a bend as shown in the figures, the dimension is measured from a top view.

Dimension D is the length as shown of first end 14, The ratio of D:A is preferably 1:1.8-2.2. In one preferred embodiment the ratio D:A is 1:2.

Dimension E is the width of plate 12.

The ratio of D:E is preferably 1:0.5-0.65. In one preferred embodiment the ratio D:E is 1:0.57 or 4:7.

Dimension B is the length of distal cap 32 and dimension C is the height of distal cap 32.

The ratio of C:B is 1:4.75-5.25. In one preferred embodiment the ratio C:B is 1:4.8

A preferred ratio of B:D:A is 3.2:3.5:7.5.

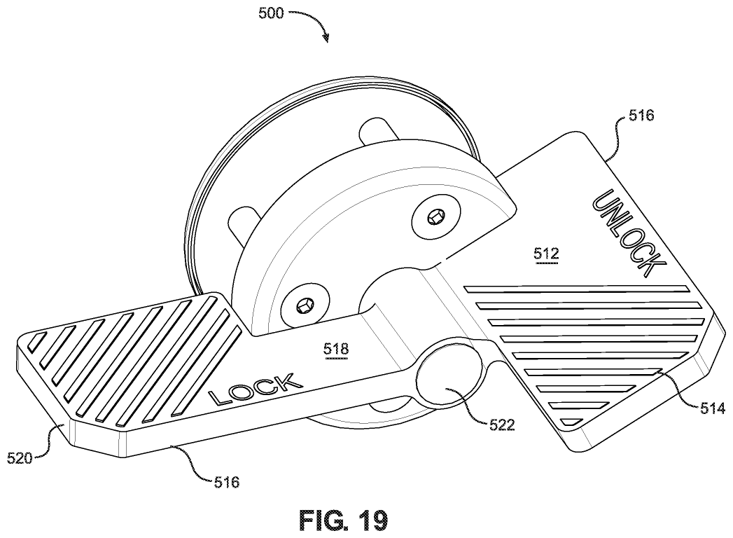

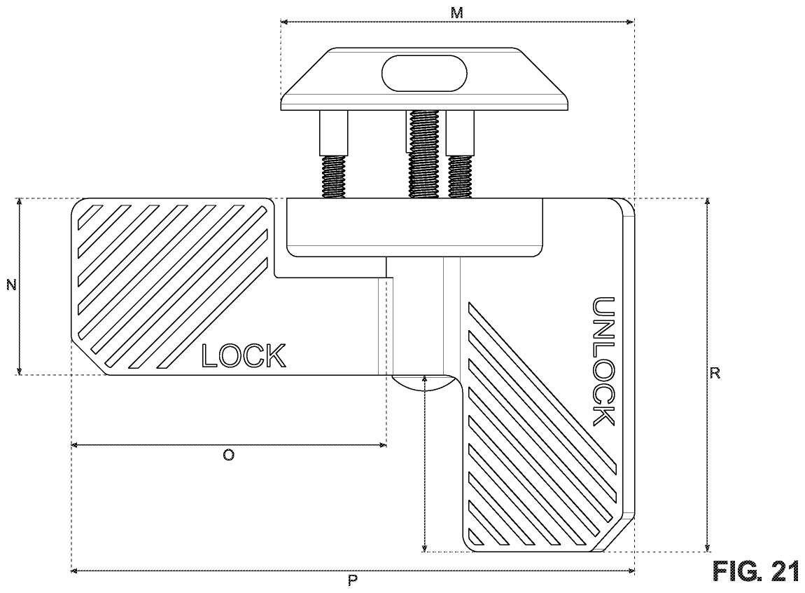

In the embodiment of FIGS. 19 and 21

System 500 is control bar 516 with first end 520 having upper surface 518. Control Bar 516 has protrusions 514 on each end as shown in the figures. Control Bar 516 rotates or pivots about central axis 522.

The ratios are as follows

Dimension N is the width of first end of control bar 516.

Dimension O is the length of plate 12

The ratio of N:O is preferably 1:0.5-0.65. In one preferred embodiment the ratio D:E is 1:0.57 or 4:7.

Dimension R is the width of second end of plate 12 in this configuration.

N:R has a ratio of 1:1.7-2.3. One preferred ratio is N:R is 1:2

Dimension P is the overall length of plate 12. Although plate 12 may not be planer, and has a bend as shown in the figures, the dimension is measured from a top view.

Ratio of R:P is 1:1.5-1.75. A preferred ratio is 1:1.58 or 4:6.33.

In all configurations, the system is installed on the lower portion of the door interior. The protrusions provide contact points whereby a user uses their foot, most often with a shoe or other footwear, and rotates the control plate to latch or lock the door into position. The locking and unlocking undertaken using the shoe so that one's hands do not handle the lock.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

What is claimed:

1. A locking system comprising:
an unlocked configuration and a locked configuration, said configurations changeable by a user utilizing a lock system having:
a control plate constructed with a first end and second end;
a mounting for said control plate to an existing door;
a central pivot connecting said control plate to said mounting;
said control plate having a first end and a second end;
a plurality of protrusions on each of said first end and a second end;
whereby said mounting is connected to said existing door at a height corresponding to less than ⅓ the total height of said existing door.

2. The system of claim 1 where each of said first end and said second end are congruently shaped.

3. The system of claim 1 where each of said first end and said second end are incongruently shaped whereby said first end has a width ratio to said second end width of 1:1.7-2.3

4. The system of claim 1 where each of said first end and said second end are incongruently shaped whereby said first end has a width ratio to said second end width of 1:2.

5. The system of claim 1 where said unlocked configuration and said locked configuration configured to be changeable by a user contacting a foot on said control plate in accordance with unlock and lock indicia disposed on said control plate.
